(19) United States
(12) Patent Application Publication
(10) Pub. No.: US 2014/0089485 A1
(43) Pub. Date: Mar. 27, 2014

(54) Method and Arrangement for Providing Update Notifications in a Telecommunication Network

(71) Applicants: Christer Boberg, Tungelsta (SE); Antonio Alonso Alarcon, Getafe (ES); Bulent Gecer, Saltsjo-Boo (SE)

(72) Inventors: Christer Boberg, Tungelsta (SE); Antonio Alonso Alarcon, Getafe (ES); Bulent Gecer, Saltsjo-Boo (SE)

(73) Assignee: TELEFONAKTIEBOLAGET L M ERICSSON (PUBL), Stockholm (SE)

(21) Appl. No.: 14/007,136

(22) PCT Filed: Mar. 29, 2011
(86) PCT No.: PCT/SE2011/050357

§ 371 Date: Dec. 2, 2013

(51) Int. Cl. H04L 12/24

(52) U.S. Cl. CPC H04L 41/50
USPC 709/223

(57) ABSTRACT

A method and arrangement in a dispatcher function in a telecommunication network for providing notifications of updates is provided. The dispatcher function receives, from a central database, an update notification. The dispatcher function identifies, at least partly based on the content of the update notification, at least one of the application server instances entitled to receive the update notification. The dispatcher function provides the data notification to the identified application server instances, thereby enabling the central database to operate in a stateless manner with respect to at least one User Equipment associated with the at least one application server instances.

### TECHNICAL FIELD

The invention relates generally to a method and arrangement for providing a notification in a telecommunication network.

### BACKGROUND

In telecommunication systems of today, new types of more advanced applications are enabled. To fully support these new types of applications, a need exists for automatically delivering information relating to data updates to users. In one example, the conventional architecture may be based on a central database which maintains and coordinates a public and/or private copy of each set of data. The data may, for example, be application data which is associated with one or more applications and one or more subscribers.

This architecture may require the database to comprise conventional mechanisms for storing and retrieving data. The database may also be required to support various triggers. The triggers may indicate relevant data change, such that an update may be sent to an application or a user, if the data change satisfies one or more predefined conditions. Thus, if data is changed and/or added to the database, it may be of importance to deliver a notification of the change in data to an application and/or subscribers and to keep a coherent copy of the data. In fact, some telecommunication standards require the central database to comprise a mechanism for providing notifications of changed data to interested parties which are served by the database. Such a mechanism requires a stateful session between the central database and each subscriber. Keeping stateful sessions in a database may require significant resources both at the client side and the server side, i.e. both at the application server and at the database. If one central database is serving a large number of users, the resources needed for keeping the stateful related information in each session may become excessive. In this document, the term “central database” shall mean one or several databases which maintain data for subscribers, application and other functions in a telecommunication network.

One example of a conventional registration procedure of a subscriber will now be described with reference to FIG. 1. A first User Equipment (UE) 101 of the subscriber registers to a network element 103 in a first action 1:1. Examples of network elements may for instance be a Serving Call Session Control Function (S-CSCF) node. The network element 103 then normally registers to a central database 104, in action 1:2, to indicate that the first UE 101 is currently associated with the network element 103. The network element will then send a register request to one or several application servers 105. Thus, in this example the network element 103 sends a request to an application server instance in action 1:3. According to one example, the services provided by the application servers are scaled by adding and/or redistributing the UFs to be served by two or more instances of an application server. Hence, one application server of a certain type is in fact composed of two or more instances of that application server. The instances of the application server is normally arranged in a cluster, hence, a cluster of application server instances normally form an application server.

Then, in action 1:4, the application server instance 105a sends a subscription request to the central database 104. In response to receiving the request from the application server instance, the central database creates a subscription for the UE101 which comprises a stateful session with application server instance 105a in action 1:5. For a second UE102, the same procedure is performed in actions 1:6-1:10. Thus, normally a separate stateful session is required for each subscriber of a service which requires corresponding notifications of data update. According to another example, the flow of events could represent a UE101 which is requesting a service via a network element 103 to an application server 105a-n.

With reference to FIG. 2, a procedure for providing notifications of data change will now be described, involving an application server 205 having application server instances 205a-c and a central database 204. A second network element 207 stores or changes data in the central database 204 in a first action 2:1. This action may trigger, in action 2:2, the central database 204 to determine, based on the subscriptions, whether or not any of the application server instances 205a-c needs to receive a notification of the data change. If so, the central database then provides the notification to the determined application server instance 205b in action 2:3. The application server instance 205b may then provide a notification to a first network element 203 in action 2:4. The first network element 203 then provides an update message to the first UE 201, if necessary, in action 2:5.

One example of an architecture where subscriptions of notifications of data changes may be utilized is the IP Multimedia Subsystem (IMS). In IMS, applications have been evolved to comprise various sharing functions, such as shared internet browsing, shared online games, shared voice sessions and instant message services. Orchestrating and managing data in IMS is often solved by a means of centralized database which is accessible for data retrieval, storage or data update. With shared applications hosted on sewers in the application plane, i.e. application servers, subscription to data changes may be an important function to provide a satisfying user experience.

Scalability of the system may become limited by using a central database which handles all states and subscriptions for each application sewer instance and also keeps track of which UE is associated with which application sewer instance. Moreover, the database according to the conventional architecture described above may become more vulnerable to failures since all information relating to the stateful sessions needs to be maintained and restored.

### SUMMARY

It is an object of the invention to address at least some of the limitations, problems and issues outlined above. It is also an object to improve the process of providing data notification in a telecommunication networks. It may be possible to achieve these objects and others by using a method and an arrangement as defined in the attached independent claims.

According to a first aspect, a method in a dispatcher function in a telecommunication network for providing notifications of updates is provided. The dispatcher function receives an update notification from a central database. The dispatcher function indentifies at least one application server instance entitled to receive the update notification. The identification is at least partly based on the content of the update notification. The data notification is then provided to the identified application server instance(s), thereby enabling the central database to operate in a stateless manner with respect to at least one User Equipment associated with the at least one application server instance.

According to another aspect, a dispatcher in a telecommunication network, adapted to provide information relating to subscriptions of update notifications, is provided. The dispatcher comprises a first receiving unit which is adapted to receive an update notification from a central database. The dispatcher also comprises an identifying unit which is adapted to identify at least one of the application server instances entitled to receive the update notification. The identification is at least partly based on the content of the update notification. The dispatcher function also comprises a first providing unit which is adapted to provide the data notification to the identified application server instance(s), thereby enabling the central database to operate in a stateless manner with respect to at least one User Equipment associated with the at least one application server instances.

The above methods, system and arrangement may be configured and implemented according to different embodiments. In one example embodiment, the at least one application server instance is identified based on a predefined identification algorithm

According to another example embodiment, where the predefined algorithm function is a consistent hashing algorithm

According to one example embodiment, where in the dispatcher receives, from the at least one application server instances, a respective individual subscription requests for update notifications from the central database. The dispatcher stored the subscription requests. The at least one application server instance is identified by comparing the content of the update notification to the stored subscription requests.

According to another example embodiment, where the update notification is a notification of an added, changed or removed data in the central database.

According to another example embodiment, the dispatcher function sends an aggregated subscription request to the central database which is at least partly based on the stored subscription requests.

According to one example embodiment, where the aggregated subscription request comprises filter conditions dictating what data to be delivered from the central database, wherein the filter conditions are also used by the dispatcher function to determine the application server instance(s).

According to one example embodiment, where subscription requests are received from application server instances and where the data notification is provided using one of a DIAMETER protocol, Hypertext Transfer Protocol SOAP or Hypertext Transfer Protocol Representational State Transfer.

According to one example embodiment, where the central database is a Home Subscriber Server (HSS) and where the application server instance(s) is an instance of an IP Multimedia System (IMS) Application Server (AS).

Further possible features and benefits of this solution will become apparent from the detailed description below.

### BRIEF DESCRIPTION OF DRAWINGS

FIG. 1 is a block diagram illustrating a registration and subscription procedure of a user equipment to a central database, according to the prior art,

FIG. 2 is a block diagram illustrating a data change notification procedure, according to the prior art,

FIG. 3 is a block diagram illustrating an optional configuration procedure for registration and subscription using a dispatcher, according to one example embodiment

FIG. 4 is a block diagram illustrating a run-time procedure for providing a data change notification from a central database, according to one example embodiment

FIG. 5a is a flow chart illustrating an optional procedure in a dispatcher for registering and optionally storing a subscription request from an application server instance, according to one example embodiment

FIG. 5b is a flow chart illustrating a procedure in a dispatcher for providing information relating to data change notifications, according to one example embodiment

FIG. 6 is an arrangement illustrating a dispaher unit, according to one example embodiment

FIG. 7 is a block diagram illustrating a computer program product, according to one example embodiment

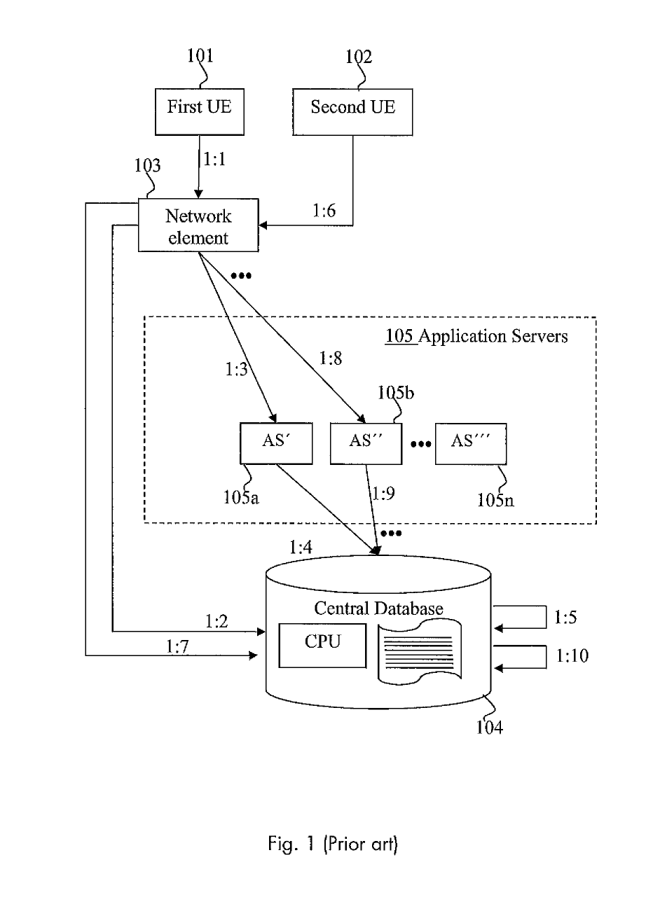

### DETAILED DESCRIPTION

Briefly described, a solution is provided for providing notifications of updates in a telecommunication network. One example of an update notification may be a notification relating to data which has been registered, added, changed or removed from a central database. This solution may reduce the required functionality in a central database by introducing a dispatcher function which is handling the dispatching of notifications from the central database to application sewers. Thus, the central database may not need any stateful sessions with any application servers and/or any UFs.

A stateless central database may be simpler to design and maintain since specific procedures for normal actions, e.g. notify or subscribe, may not required to be supported.

In telecommunication systems, e.g. IMS, application servers provides certain services to UFs. An application sewer is perceived as one logical unit However, in order to balance and scale a service provided by an application sewer, instances of the same application server is used. In order to maintain this balance, the UFs sometimes need to be redistributed over the current application sewer instances. This redistribution is normally done when scaling the service, e.g. when adding registered subscribers to a service.

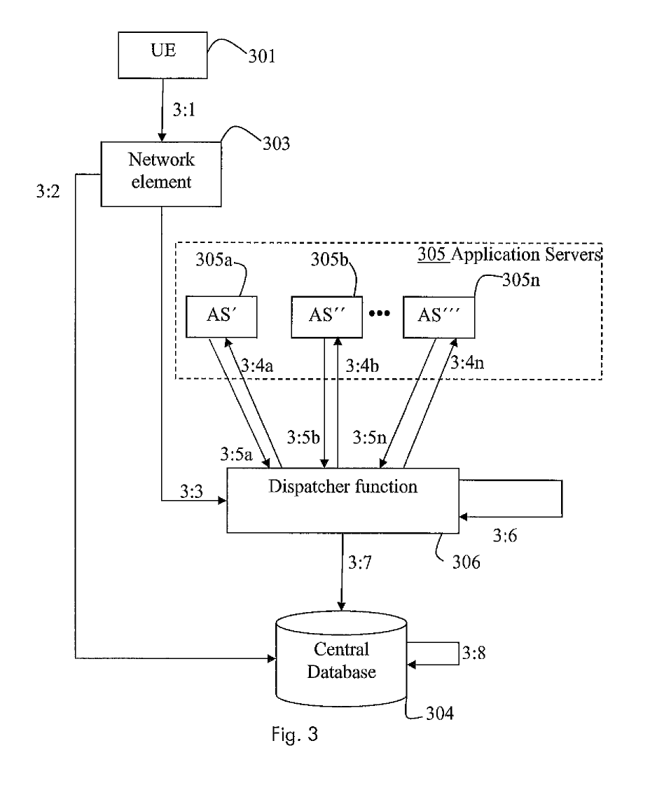

With reference to FIG. 3, a procedure for registering a UE301 of a subscriber to an application sewer instance 305a-n will now be described. By using this procedure for registering and configuring, the central database 304 may not be required to keep a stateful with the UFs and/or the application sewer instance(s).

A UE301 of the subscriber registers to a network element 303 in a first action 3:1. The network element 303 then normally registers its connection to the first UE 30l to a central database 304, in action 3:2, to indicate that the UE301 is currently associated with the network element 303. Then the network element 303 registers to a dispatcher function 306 in action 3:3, instead of registering directly to the application server instance 305a-n.

According to one solution, the dispatcher function maintains the balance between the application server instances. According to another solution, the application server instance which is subject for the register request is predefined. Regardless, the dispatcher function 306 issues a request for registering the UE301 to one or more application instances 305a-n, which is indicated by an action 3:4a-n. Based on the request for registering, the application server instance 305a-n register the UE301 to be served and responds to the dispatcher function 306 with an acknowledgement, which is illustrated in action 3:5a-n, and optionally also a data condition, e.g. a filter comprising rules for which data the application instance is interested in taking part of updates from.

In action 3:6, the dispatcher function 306 updates a predefined identification algorithm if needed, i.e. the application server instances which are comprised in a cluster forming an application server is added to the predefined identification algorithm. The predefined identification algorithm may analyze the content of an update notification and thereby identify which application server instance which is eligible to receive the notification update. According to one particular example, the registering UFs are associated with an application server instances by using consistent hashing.

According to an alternative solution, the dispatcher function keeps a stateful session with the application server instances by using a record or a list

According to another possible alternative embodiment of the configuration procedure which is illustrated in the action 3:1-3:6, the disptacher function may be preconfigured with the existing application server instances in each application server cluster. Thus, there may be no requirement for the application sewers to subscribe to the disptacher function. In such alternative embodiment, the actions 3:1-3:6 may be omitted.

While the dispatcher function is now ready to identify the receiving application server instance(s) based on an update notification from the central database, additional functionality is possible. In an optional action 3:7, the dispatcher function may provide an update notification subscription to the central database. The subscription in action 3:7 may be an aggregated subscription, i.e. an update is only omitted if it is not relevant to any of the application servers associated with the dispatcher function.

Thus, the central database may create a stateful subscription to the dispatcher function based on the request of action 3:7, which is further indicated in action 3:8. However, the central database will only have to maintain one subscription per dispatcher function, instead of one subscription per subscriber of an UE301.

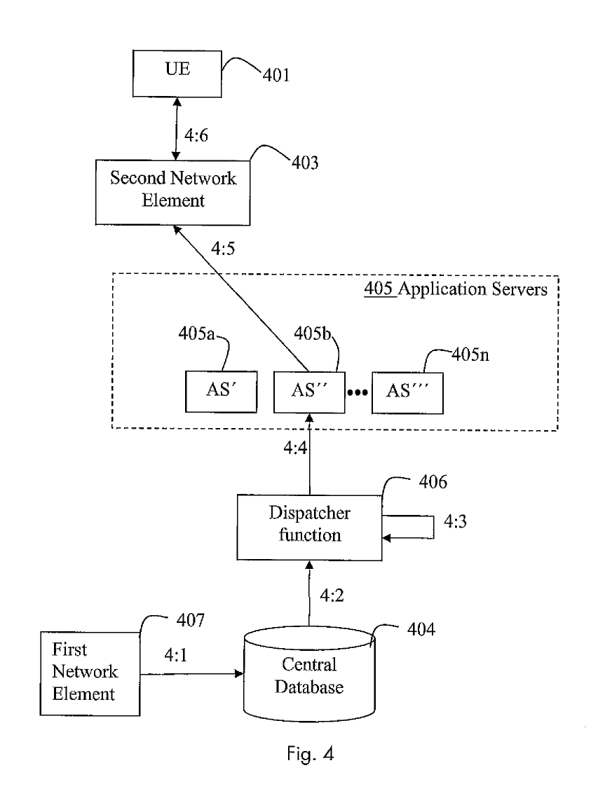

With reference to FIG. 4, a procedure for providing a notification of update to an application sewer instance will now be described. A first network element 407 stores or changes data in the central database 404 in a first action 4:1. In order to enable the solution to minimize the requirement of the central database 404, the subsequent action 4:2 may be performed according to at least two alternatives. According to a first alternative, the central database 404 provides an update notification to the dispatcher function regardless of the nature of the data which has been updated. Thus, the central database 404 may be configured to, in a rigid manner, provide any update notification to the dispatcher function.

According to a second optional alternative, the central database 404 may decide whether or not a update notification should be issued based on a subscription which is described with reference to action 3:7 in FIG. 3.

The dispatcher function 406, receives the update notification which is provided in action 4:2. Then, the dispatcher function 406 identifies, based on the content of the update notification, which application server instance(s) that should be provided with the update notification in action 4:3. The dispatcher function may identify the eligible application server based on an identification algorithm. According to one possible solution, the dispatcher function identifies the eligible application server instance(s) using a consistent hashing algorithm. However, more simplistic identification algorithms, which exist in profusion, may be used to identify the eligible application server instance.

According to another possible solution which is not using an identification algorithm, the dispatcher function compares the content of the notification update to stored record, or application server instance subscription, to identify the eligible application server. Regardless of which identification technique that is used in action 4:3, the dispatcher function provides the application server instance(s) with the data notification update, which is illustrated in action 4:4. Naturally, if the update notification is not relevant to any application server instance or to any subscriber of a UE, then nothing is provided.

When the application server instance 405a-n receives the data notification update, necessary application specific actions may be performed. According to one possible example, additional data and/or an update notification may be provided to a second network element 403, which is illustrated in action 4:5. The network element may then, using its connection or relation to the UE401, provide the data and/or update notification in action 4:6.

According to one possible optional solution, the dispatcher function may implement one or several of the actions which are described with reference to FIGS. 3-4 by using any one of a DIAMETERprotocol, SOAP or Representational State Transfer (REST) in HTTP.

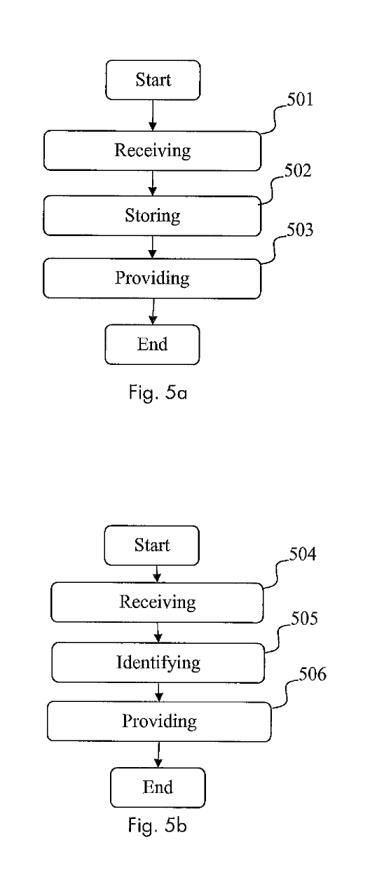

With reference to FIG. 5a, will now a flowchart be described. The flowchart of FIG. 5 illustrates the actions of an optional procedure configuring a dispatcher function to provide notification updates to one or more application server instance(s). The procedures disclosed with reference to FIG. 5 may be performed by implementing the actions of the signaling diagrams of FIG. 3.

As it is shown, a first action 501 performed in a dispatcher function comprises to receive an subscription request from one or more application server instances. Each application server may be required to provide an individual subscription request to the dispatcher function so that the dispatcher function is aware of the applications server instances in a application server cluster. The subscription requests for notifications of updates in a central database.

As indicated by action 502, the dispatcher function stores the subscription request The dispatcher function may also update a record for maintaning which subscriber that is served by which application server instance. According to one example, the record may comprise a consistent hashtable. Thus, the application server instance is added as a possible receipient in the consistent hashtable.

According to another possible alternative embodiment of the configuration procedure, in which the dispatcher function may be preconfigured with the existing application server instances in each application server cluster. Thus, there may be no requirement for the application servers to subscribe to the disptacher function. In such alternative embodiment, the actions 501 and 502 may be omitted.

Now, the dispatcher function is configured to receive and dispatch updates from the central database. However, in an optional action 503, an additional request of subscription may be provided to the central database. Thus, the central database creates and/or updates a subscription to serve the dispatcher function according to the subscription request The request of action 503 may comprise a data condition, i.e. a filter rule, which is aggregated for all the application sewers instances which have subscribed to the dispatcher function.

With reference to FIG. 5b, a flow chart illustrating the procedure of providing an update notification to an application server will now be described.

Once the central database is manipulated, an update notification is sent from the central database to the dispatcher function, which is indicated in action 504. According to one alternative, the central database provides an update notification regardless of the nature of the update. According to another alternative, the update is compared to the subscription which is performed and described in action 503. The dispatcher function identifies, based on the content of the notification update, one or more application sewer instances which is entitled to the update notification which is indicated in action 505. The identification mechanism in action 505 may be based on an identification algorithm. According to one possible solution, the dispatcher function identifies the eligible application sewer instance(s) using a consistent hashing algorithm. However, more simplistic identification algorithms, which exist in profusion, may be used to identify the eligible application sewer.

Once the recipients, i.e. the receiving application sewers, are identified the dispatcher function provides the data notification update to the identified application sewer instance(s), which is indicated in action 506.

The above procedure of fig's 5a-b can be modified in different ways without departing from the invention. For example, one or several actions may be performed in a different order, or in a combined action, but still reach the same technical effect

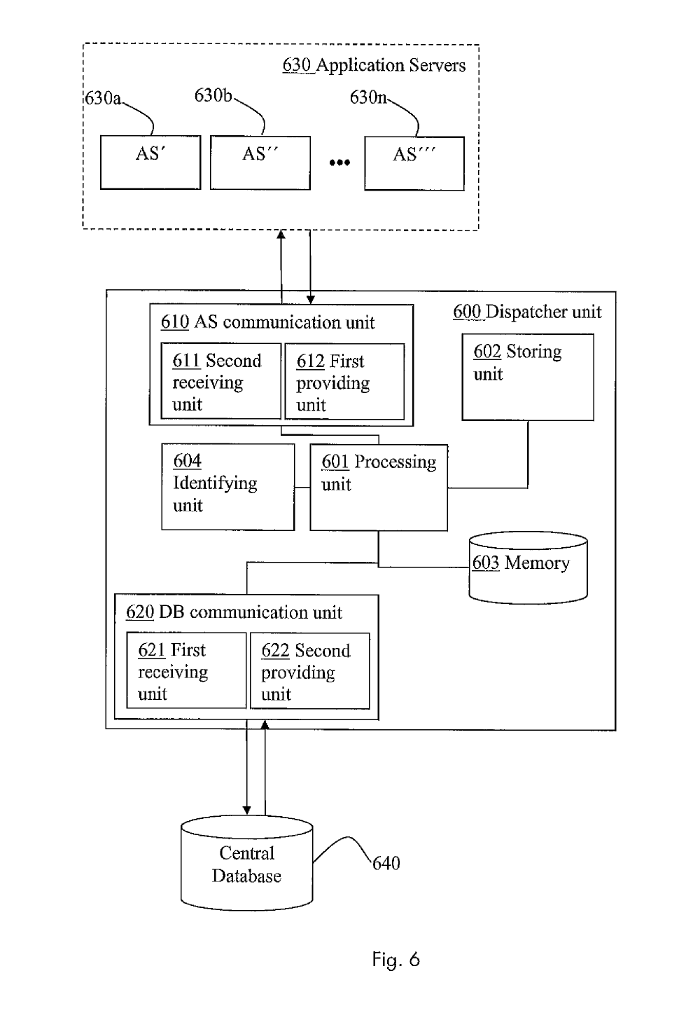

With reference to FIG. 6, a dispatcher unit 600 adapted to perform the related actions of FIG. 3-5, will now be described. The dispatcher unit 600 comprises a database communication unit 620, adapted to communicate with the central database 640. Hence, the database communication unit 620 comprises a first receiving unit 621, adapted to receive an update notification from the central database 640.

The dispatcher unit 600 comprises an application server communication unit 610 which is adapted to communicate with one or more application server instances 630a-n. The application server communication unit 610 may comprise a second receiving unit 611, which is adapted to receive requests from the application servers 630a-n, and a first providing unit 612, which is adapted to provide update notifications to the application server instances 630a-n. The second receiving unit 611 may be adapted to receive subscription requests for notifications from one or more application servers instances 630a-n. The dispatcher unit 600 further may comprise a storing unit 602, adapted to store the subscription request which is received by the first receiving unit 611.

According to one example embodiment of the arrangement in FIG. 6, the second receiving unit 611 and the storing unit 602 may enable the dispatcher unit 600 to identify which application server instance that are eligible for updates provided by a central database 640. This may be done by maintaining and storing a list of eligible application server instances based on the requests received by the second receiving unit 611.

The database communication unit 620 may also comprises a second providing unit 622 which is adapted to provide a subscription request, which is an aggregation of the application server instances' subscriptions, to the central database 640.

An update notification, which is received by the first receiving unit 621 from the central database 640, is analyzed by an identifying unit 604 to identify, at least partly based on the content of the update notification, one or more application server instances entitled to receive the update notification. The identifying unit 604 may be adapted to use an identification algorithm in order to identify the application server instance(s) eligible for the update notification. According to one possible solution, the identifying unit 604 identifies the eligible application server instance(s) using a consistent hashing algorithm. However, more simplistic identification algorithms, which exist in profusion, may be used by the identifying unit 604 to identify the eligible application server. According to another possible solution, the identifying unit 604 may be adapted to identify eligible application server instances by comparing the content of the update notification to a record or a list of subscriptions stored by the storing unit 602. A first providing unit 612 is adapted to, after the identification of the eligible application server instance(s), provide the update notification to the application server instances which are identified by the identifying unit 604. Any one of the second receiving unit 611, the first providing unit 612, the first receiving unit 621 and/or the second providing unit 622 may be adapted to communicate using any one of a DIAMETERbased protocol, SOAP or Representational State Transfer (REST) in HTTP.

The dispatcher unit 600 may also comprise a processing unit 601, e.g. a Digital Signal Processor (DSP). The processing unit 601 can be a single unit or a plurality of unit to perform different actions of procedures described herein. The dispatcher unit 600 may also comprise a non-volatile memory 603, e.g. an Electrically Erasable Programmable Read-Only Memory (EEPROM), a flash memory and a disk drive. The memory 603 may comprise code means for which may be executed by the processing unit 601.

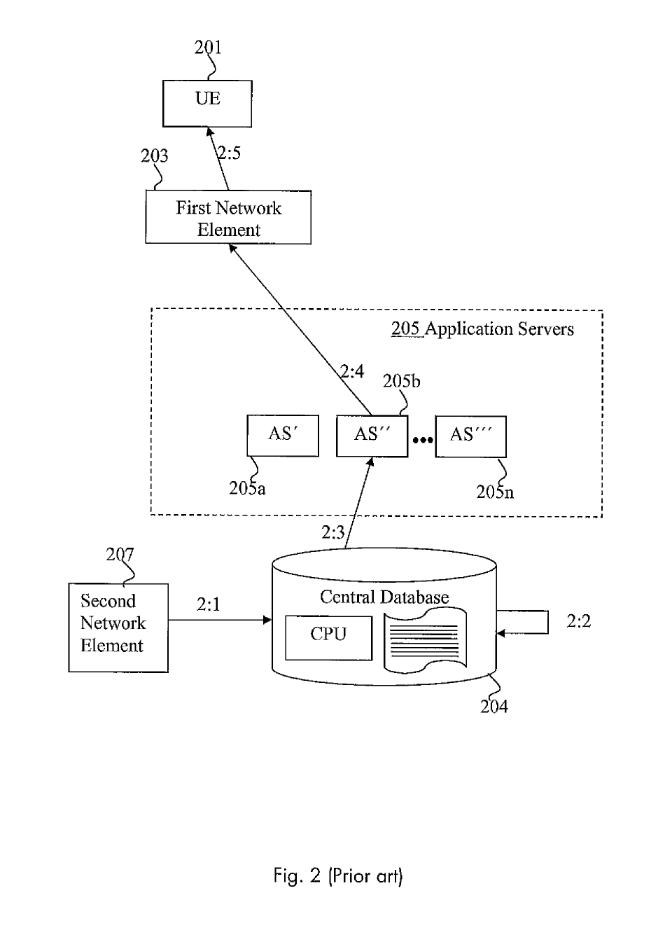

It should be noted that FIG. 6 merely illustrates various functional modules or units in the dispatcher function in a logical sense, although the skilled person is free to implement these functions in practice using suitable software and hardware means. Thus, this aspect of the solution is generally not limited to the shown structures of the notification server 600, while its functional modules 601, 602, 604, 610, 620 may be configured to operate according to the features described for any of FIGS. 2-5b above, where appropriate.

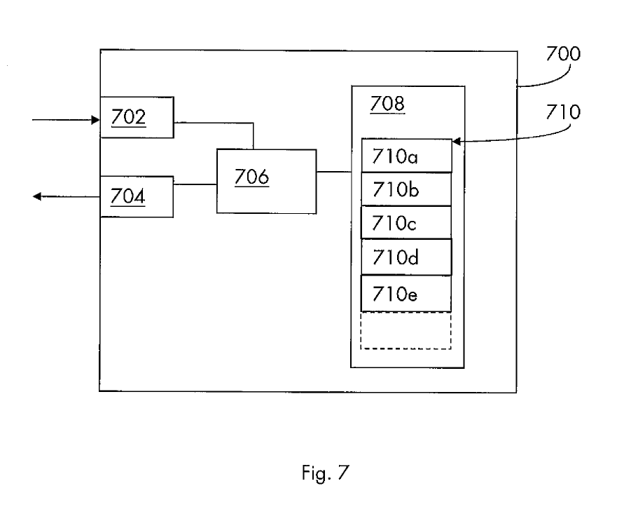

FIG. 7 schematically shows an embodiment of an arrangement 700 in a dispatcher unit, a database or in an application server, which also can be an alternative way of disclosing an embodiment of the arrangement for providing notifications in a telecommunication network, which are illustrated in FIG. 6. Comprised in the arrangement 700 are here a processing unit 706, e.g. with a DSP The processing unit 706 can be a single unit or a plurality of unit to perform different actions of procedures described herein. The arrangement 700 may also comprise an input unit 702 for receiving signals and information from other entities, and an output unit 704 for providing signals and information to other entities. The input unit 702 and the output unit 704 may be arranged as an integrated entity.

Furthermore, the arrangement 700 comprises at least one computer program product 708 in the form of a non-volatile memory, e.g. an EPROM (Electrically Erasable Programmable Read-Only Memory), a flash memory and a disk drive. The computer program product 708 comprises a computer program 710, which comprises code means, which when run in the processing unit 706 in the arrangement 700 causes the arrangement and/or the dispatcher function and/or the database and/or the application server to perform the actions of the procedures described earlier in conjunction with FIGS. 3-5b.

The computer program 710 may be configured as a computer program code structured in computer program modules. Hence in the example embodiments described, the code means in the computer program 710 of the arrangement 700 comprises a first receiving module 710a for receiving the subscription request from an application server instance. The computer program further comprises a storing unit module 710b for storing the subscription request The computer program 710 further comprises a second receiving module 710c for receiving an update notification from a central database. The computer program 710 further comprises an identifying module 710d for identifying at least partly based on subscription requests which are stored by the storing module 710b, one or more application server instances entitled to receive the update notification. The computer program 710 further comprises a providing unit 710e which is adapted to provide the update notification to the identified application sewers. The first and second receiving module as well as the providing module may be adapted to communicate using the output unit 704 and/or the input unit 702.

The modules 710a-e could essentially perform the actions of the flow illustrated in FIG. 3-5b, to emulate the arrangementing a dispatcher according to FIG. 6. In other words, when the different modules 810a-d are run on the processing unit 706, they correspond to the unit 601, 602, 604, 611, 612, 621, 622 of FIG. 6.

Although the code means in the embodiment disclosed above in conjunction with FIG. 7 are implemented as computer program modules which when run on the processing unit causes the arrangement and/or dispatcher unit and/or the database and/or the application sewer to perform the actions described above in the conjunction with figures mentioned above, at least one of the code means may in alternative embodiments be implemented at least partly as hardware circuits.

The processor may be a single CPU (Central processing unit), but could also comprise two or more processing unit. For example, the processor may include general purpose microprocessors; instruction set processors and/or related chips sets and/or special purpose microprocessors such as ASICs (Application Specific Integrated Circuit). The processor may also comprise board memory for caching purposes. The computer program may be carried by a computer program product connected to the processor. The computer program product comprises a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program product in the form of memories within the data receiving unit.

Several advantages may be achieved by using a dispatcher function, or dispatcher unit, as described above in this description. For example, if the dispatcher function may enable a completely stateless notification procedure. According to another example, the state may be located to the dispatcher function instead of keeping the states in the central database. Moreover, additional functionality such as protocol transformation may be added to the dispatcher instead of intervening with the central database. The central database may also be designed to meet other requirements. For example, the central database may be adapted to buffer update notifications and provide a bundle of notification updates to a dispatcher which dispatches the notification to each eligible application server instance.

Possible effects may be increased robustness, a faster providing procedure for update notification and increased scalability. The central database may hence require less hardware per served subscriber and/or application server.

While the invention has been described with reference to specific exemplary embodiments, the description is generally only intended to illustrate the inventive concept and should not be taken as limiting the scope of the invention. For example, the terms “application server”, “application sewer instance”, “central database”, “notification update”, and “dispatcher function”, have been used throughout this description, although any other corresponding functions, parameters, nodes and/or units could also be used having the functionalities and characteristics described here. The invention is defined by the appended claims.

1-18. (canceled)

19. A method, in a dispatcher function in a telecommunication network, for providing notifications of updates, comprising:
receiving an update notification from a central database;
identifying, at least partly based on the content of the update notification, at least one application server instance entitled to receive the update notification;
providing the update notification to the identified application server instance(s), thereby enabling the central database to operate in a stateless manner with respect to at least one User Equipment associated with the at least one application server instance.

20. The method of claim 19, wherein the identifying comprises identifying the at least one application server instance using a predefined identification algorithm.

21. The method of claim 20, wherein the predefined algorithm is a consistent hashing algorithm.

22. The method of claim 19, wherein the update notification comprise a notification of added, changed, or removed data in the central database.

23. The method of claim 19, further comprising:
receiving, from the at least one application server instance, a respective individual subscription request for update notifications from the central database;
storing the subscription request;
wherein the identifying comprises identifying the at least one application server instance by comparing content of the update notification to the stored subscription request.

24. The method of claim 23, further comprising the dispatcher function sending an aggregated subscription request to the central database which is at least partly based on the stored subscription requests.

25. The method of claim 24:
wherein the aggregated subscription request comprises filter conditions dictating what data is to be delivered from the central database;
wherein the identifying comprises identifying the at least one application server instance based on the filter conditions.

26. The method of claim 23:
wherein the receiving the subscription request is performed using one of a DIAMETER protocol, a Hypertext Transfer Protocol SOAP, and a Hypertext Transfer Protocol Representational State Transfer;
wherein the providing the update notification is performed using one of a DIAMETER protocol, a Hypertext Transfer Protocol SOAP, and a Hypertext Transfer Protocol Representational State Transfer.

27. The method of claim 19:
wherein the central database is a Home Subscriber Server;
wherein the at least one application server instance is an instance of an IP Multimedia System Application Server.

28. A dispatcher, in a telecommunication network, adapted to provide information relating to subscriptions of update notifications, the dispatcher comprising:
a first receiving circuit configured to receive a update notification from a central database;
an identifying circuit configured to identify, at least partly based on the content of the update notification, at least one application server instance entitled to receive the update notification;
a first providing circuit configured to provide the update notification to the identified application server instance(s), thereby enabling the central database to operate in a stateless manner with respect to at least one User Equipment associated with the at least one application server instances.

29. The dispatcher of claim 28, wherein the identifying circuit is further configured to identify the at least one application server instance using a predefined identification algorithm.

30. The dispatcher of claim 29, wherein the predefined identification algorithm is a consistent hashing algorithm.

31. The dispatcher of claim 29, wherein the update notification comprises a notification of an added, changed, or removed data in the central database.

32. The dispatcher of claim 28, further comprising:
a second receiving circuit, configured to receive, from a plurality of application server instances, respective individual subscription requests for notifications of updates in a central database;
a storing circuit configured to store the subscription request(s);
wherein the identifying circuit is configured to identify the at least one application server instance by comparing content of the update notification to the stored subscription request(s).

33. The dispatcher of claim 32, further comprising a second providing circuit configured to provide an aggregated subscription request to the central database which is at least partly based on the stored subscription request(s).

34. The dispatcher of claim 33:
wherein the aggregated subscription request comprises filter conditions dictating what data is to be delivered from the central database;
wherein the identifying circuit is configured to identify the application server instance(s) based on the filter conditions.

35. The dispatcher of claim 33, wherein at least one of, the first receiving circuit, the first providing circuit, the second receiving circuit, and the second providing circuit, is configured to communicate with the central database or application server instance using at least one of:
a DIAMETER protocol;
a Hypertext Transfer Protocol SOAP;
a Hypertext Transfer Protocol Representational State Transfer.

36. The dispatcher of claim 28:
wherein the central database is a Home Subscriber Server;
wherein the at least one application server instance is an instance of an IP Multimedia System Application Server.
